(19) United States
(12) Patent Application Publication
(10) Pub. No.: US 2025/0368539 A1
(43) Pub. Date: Dec. 4, 2025

(54) CATHODE MATERIAL AND MANUFACTURING METHOD THEREOF

(71) Applicant: CPC CORPORATION, TAIWAN, Kaohsiung City (TW)

(72) Inventors: Shih-An LIU, Kaohsiung City (TW); Jui-Hsiung HUANG, Kaohsiung City (TW)

(73) Assignee: CPC CORPORATION, TAIWAN, Kaohsiung City (TW)

(21) Appl. No.: 18/774,701

(22) Filed: Jul. 16, 2024

(30) Foreign Application Priority Data
May 30, 2024 (TW) 113120104

(51) Int. Cl. C01G 53/00

(52) U.S. Cl. CPC C01G 53/54; C01P 2004/80

(57) ABSTRACT

Disclosed is a cathode material, comprising a core, composed of a first material; and a coating, covering the core and composed of a second material, wherein the first material is represented by: LiNi_{0.5}Mn_{1.5}O_{4-δ}, wherein δ>0, and the second material is Li-containing ternary halide.

### FIELD OF THE INVENTION

The present invention relates to a cathode material and a manufacturing method thereof and more particularly relates to a cathode material having a core of lithium nickel manganese oxide metal materials and a coating of lithium-containing ternary halide.

### BACKGROUND OF THE INVENTION

Lithium batteries have the advantage of high energy density and are the mainstream energy storage components for today's portable electronic devices. Through appropriate material selection and modification, the operating voltage and specific capacitance of the lithium battery can be improved, and the energy density of lithium battery products is further enhanced, thus making lithium battery products effectively applicable in the field of energy storage and electric vehicles.

Cathode materials account for about 40% of the overall cost of lithium batteries, and thus the cost of cathode materials could be considered as the main factor to determine the price of lithium batteries. Moreover, the cathode material determines the performance of lithium batteries in terms of energy density, safety, and cycle life.

However, lithium nickel manganese oxide (LNMO) as a cathode material for lithium batteries has the disadvantage of capacity decay because Mn³⁺ in its composition may induce a disproportionate reaction to cause manganese dissolution and structural changes in the spinel structure.

### SUMMARY OF THE INVENTION

The ideal lithium nickel manganese oxide has the chemical formula LiNi_{0.5}Mn_{1.5}O₄ and is mainly a P4₃32 space group with a spinel structure and Mn⁴⁺ maintains the oxidation valence during the charge and discharge process and does not participate in the reaction to maintain structural stability. However, in the conventional technology, different manufacturing processes may cause Mn³⁺ to present in LNMO. For maintaining electrical neutrality, “oxygen loss” may occur to form LiNi_{0.5}Mn_{1.5}O_{4-δ}, whose crystal structure is changed to Fd-3m. Although the Fd-3m composition is not favorable for structural stability, it gains a better discharge rate performance.

As mentioned above, the presence of Mn³⁺ in LNMO materials varies the electrochemical performance of the materials to thus have both advantages and limitations. Therefore, the inventor of the present invention conceives that by coating the LiNi_{0.5}Mn_{1.5}O_{4-δ} material with a halide material layer, it can effectively prevent direct contact between LiNi_{0.5}Mn_{1.5}O_{4-δ} and the electrolyte, and at the same time maintains good ionic conductivity and excellent cycle stability.

Therefore the objective of present invention is to provide a cathode material and a manufacturing method thereof to address issues in the prior art.

In order to overcome the technical problems in prior art, the present invention provides a cathode material, comprising a core, composed of a first material; and a coating, covering the core and composed of a second material, wherein the first material is represented by: LiNi_{0.5}Mn_{1.5}O₄₋₆, wherein δ>0, and the second material is Li-containing ternary halide.

One embodiment of the present invention provides a cathode material, wherein the second material is represented by: LiₐMX_{b}, wherein M is non-lithium metal, X is halogen, and a and b are positive integers.

One embodiment of the present invention provides a cathode material, wherein the second material is lithium-indium chloride (Li₃InCl₆).

One embodiment of the present invention provides a cathode material, wherein the coating has a thickness of 5˜60 nm.

The present invention provides a manufacturing method of a cathode material, comprising a co-precipitation step of mixing a nickel-manganese metal solution, a sodium hydroxide solution and an ammonia solution in a container to obtain a co-precipitation product, and drying and then sieving the co-precipitation product to obtain a nickel-manganese precursor; a sintering step of adding and mixing lithium salt to the precursor and then performing a sintering treatment in an oxygen-deficient environment thereon to obtain a first material; and a coating step of adding and mixing the first material to halide to obtain a coating mixture, and then drying and vacuum-sintering the coating mixture to obtain the cathode material, wherein the molar ratio of nickel to manganese in the nickel-manganese metal solution is 1:3.

One embodiment of the present invention provides a cathode material, wherein in the sintering step, the sintering treatment is carried out in a nitrogen atmosphere.

One embodiment of the present invention provides a cathode material, wherein in the sintering step, the sintering treatment is carried out at a temperature of 500˜1000° C. for 1˜13 hours.

One embodiment of the present invention provides a cathode material, wherein in the coating step, the weight of the halide accounts for 1 to 10% of the total weight of the coating mixture.

One embodiment of the present invention provides a cathode material, wherein in the coating step, the sintering treatment is carried out at a temperature of 150˜250° C. for 4˜6 hours.

The present invention relates to a cathode material, specifically referring to a cathode material having a core of lithium nickel manganese oxide metal materials and a coating of lithium-containing ternary halide. The present invention also relates to a manufacturing method of a cathode material, specifically referring to a manufacturing method of coating a lithium nickel manganese oxide metal material with a lithium-containing halide coating material. The manufacturing method prepares a nickel-manganese precursor by means of co-precipitation, then obtain LiNi_{0.5}Mn_{1.5}O_{4-δ} material by performing a sintering treatment in an oxygen-deficient environment, and finally prepares, through a sol-gel method, Li₃InCl₆-coated LiNi_{0.5}Mn_{1.5}O_{4-δ} material as the cathode material in the present invention, which is also referred to as LIC@LiNi_{0.5}Mn_{1.5}O_{4-δ} in the specification.

The Li₃InCl₆-coated LiNi_{0.5}Mn_{1.5}O_{4-δ} material can effectively prevent direct contact between the material and the electrolyte, and at the same time maintain good ionic conductivity and cycle stability.

### BRIEF DESCRIPTION OF THE DRAWINGS

FIG. 1 is a schematic drawing illustrating the structure of a cathode material according to an embodiment of the present invention;

FIG. 2 is a schematic drawing illustrating the results of the Fourier transform infrared spectroscopy of the cathode material according to the embodiment of the present invention;

FIG. 3 is a schematic drawing illustrating the results of the Raman spectroscopy of the cathode material according to the embodiment of the present invention;

FIG. 4 is a schematic drawing illustrating the results of the discharge rate test of the cathode material according to the embodiment of the present invention;

FIG. 5 is a curve chart illustrating the results of the cycle test of the cathode material according to the embodiment of the present invention.

### DETAILED DESCRIPTION OF THE PREFERRED EMBODIMENTS

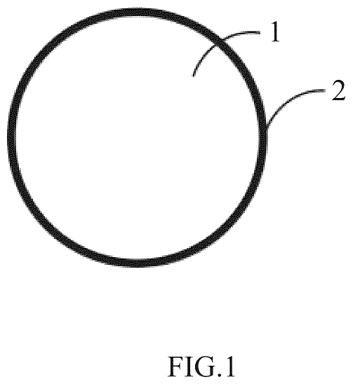

The preferred embodiments of the present invention are described in detail below with reference to FIG. 1 to FIG. 5. The description is used for explaining the embodiments of the present invention only, but not for limiting the scope of the claims.

A cathode material according to one embodiment of the present invention comprises: a core 1, composed of a first material; and a coating 2, covering the core 1 and composed of a second material.

The first material is represented by: LiNi_{0.5}Mn_{1.5}O_{4-δ}, wherein δ>0, and the second material is Li-containing ternary halide.

In the cathode material according to the embodiment of the present invention, the second material is represented by LiₐMX_{b}, wherein M is non-lithium metal, X is halogen, and a and b are positive integers.

As the second material represented by LiₐMX_{b}, lithium indium chloride (Li₃InCl₆) is preferred.

In the cathode material according to the embodiment of the present invention, the coating has a thickness of 5˜60 nm.

The cathode material with the aforementioned technical features can effectively enhance the performance during charge and discharge in different rate and improve the cycle life performance when used as an electrode in lithium batteries.

A manufacturing method of a cathode material according to one embodiment of the present invention comprises: a co-precipitation step of mixing a nickel-manganese metal solution, a sodium hydroxide solution and an ammonia solution in a container to obtain a co-precipitation product, and drying and then sieving the co-precipitation product to obtain a nickel-manganese precursor; a sintering step of adding and mixing lithium salt to the precursor and then performing a sintering treatment in an oxygen-deficient environment thereon to obtain a first material; and a coating step of adding and mixing the first material to halide to obtain a coating mixture, and then drying and vacuum-sintering the coating mixture to obtain the cathode material.

The molar ratio of nickel to manganese in the nickel-manganese metal solution is 1:3.

In the manufacturing method according to the embodiment of the present invention, in the sintering step, the sintering treatment is carried out in a nitrogen atmosphere.

In the manufacturing method according to the embodiment of the present invention, in the sintering step, the sintering treatment is carried out at a temperature of 500˜1000° C. for 1˜13 hours.

In the manufacturing method according to the embodiment of the present invention, in the coating step, the weight of the halide accounts for 1 to 10% of the total weight of the coating mixture.

In the manufacturing method according to the embodiment of the present invention, in the coating step, the sintering treatment is carried out at a temperature of 150˜250° C. for 4˜6 hours.

The manufacturing method of the present invention is then described in further detail in accordance with following examples, but the present invention is not limited thereto.

### Example 1

The preparation of oxygen-deficient lithium nickel manganese oxide material (LiNi_{0.5}Mn_{1.5}O_{4-δ}) first includes the co-precipitation step: nickel sulfate (NiSO₄·6H₂O), manganese sulfate (MnSO₄·H₂O) and ammonium sulfate ((NH₄OH)SO₄) are prepared as a feed metal solution in a molar ratio of 1:3:1. 18% ammonia solution is prepared as a chelating agent, and 1.2M sodium hydroxide solution as a precipitating agent. A 2-liter glass reactor is used as a co-precipitation tank, and a diluted ammonia solution is used as a starting solution. The feed metal solution and the chelating agent are injected into a glass reactor by a peristaltic pump with feed flow rate of 40 ml/hour and 20 ml/hour respectively. During the reaction, the pH value is set at 10.2±0.1 by a pH controller, and when the pH value deviates from the set value, the precipitant is added by the dosing pump to maintain the proper reaction environment. The reactor temperature is set to 40° C., the mixer speed is set to 2000 rpm, and nitrogen is used as a protective atmosphere. When the solution in the reactor is full to the overflow port, it is guided to the overflow tank through the plastic conduit to collect the co-precipitated product. Finally, the precipitate is centrifugally washed with pure water, dried in an oven at 80° C., and then sieved to obtain the nickel-manganese precursor. After the co-precipitation reaction precursor was sieved, lithium carbonate and two zirconium balls (diameter 1 cm) are added at the appropriate molar ratios and mixed in a 3D mixer for 16 hours. The mixed powders are sintered in a tube furnace with a nitrogen atmosphere, heated from room temperature at a heating rate of 1° C./min to 910° C. and held for 12 hours, then lowered to 600° C. and held for 12 hours, then cooled to room temperature, and sieved to obtain the of LiNi_{0.5}Mn_{1.5}O_{4-δ} material.

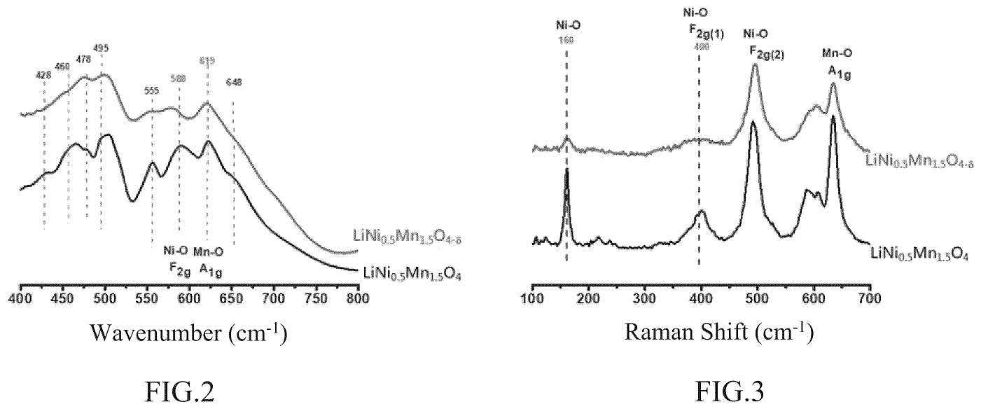

Next, FT-IR and Raman spectral analysis were used to verify the oxygen-deficient structure. The results of FT-IR and Raman spectrum analysis are shown in FIGS. 2 and 3, which show that the absorption peaks of the Ni—O bond in LiNi_{0.5}Mn_{1.5}O_{4-δ} are weakened.

### Example 2

Next, the cathode material according to the manufacturing method of the present invention is prepared by first dissolving lithium chloride (LiCl) and indium chloride (InCl₃) with a molar ratio of 3:1 in deionized water, then adding the LiNi_{0.5}Mn_{1.5}O_{4-δ} material of example 1 to the aqueous solution at a ratio of 95 wt %, and evenly mixing the materials by ultrasonic vibration. The solution was then dried at 100° C. for two days to obtain dry powder, and finally sintered at 200° C. for five hours to obtain 5% LIC@LiNi_{0.5}Mn_{1.5}O_{4-δ} material.

### (Electrical Performance Test)

In order to understand the effect on the charge and discharge performance of the battery when the cathode material of the present invention is applied to the battery, the battery is prepared according to the following method, and is subjected to charge and discharge test.

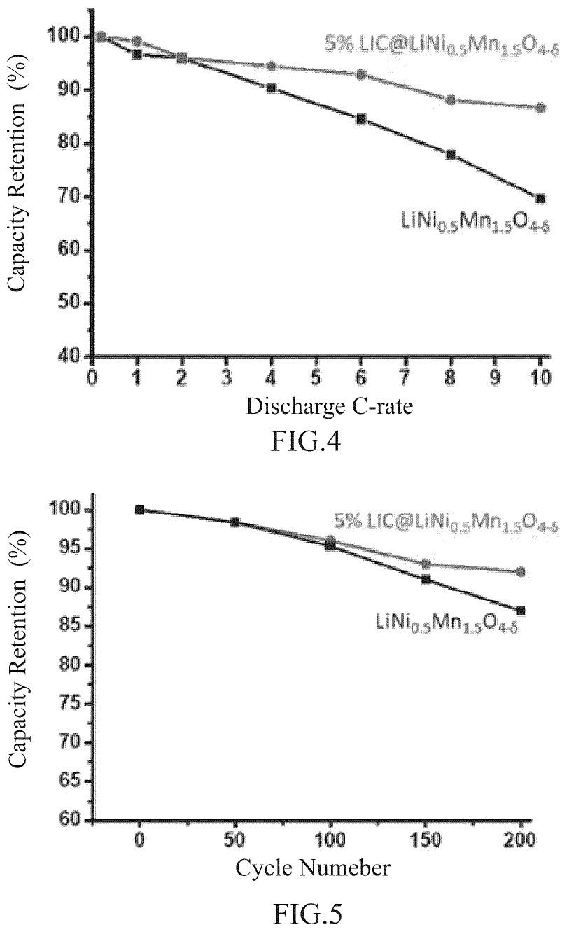

The electrical performance test is divided into a example 1 group and example 2 group. First, 1.5 g of polyvinylidene fluoride (PVDF) is added to 24.75 g of N-methylpyrrolidone (NMP) and mixed, after polyvinylidene fluoride is completely dissolved, 12 g of the cathode material of the example 1 (LiNi_{0.5}Mn_{1.5}O_{4-δ} material) or example 2 (LIC@LiNi_{0.5}Mn_{1.5}O_{4-δ} material) is added, and then 1.5 g of conductive carbon material is added and fully mixed, then the slurry is coated on an 18-micron aluminum foil with a 120-micron scraper, and then the aluminum foil is baked in an oven at 120° C. to complete the preparation of the battery electrode, wherein the weight ratio of the active material, the conductive carbon material and the adhesive is 80:10:10. Before assembling the battery, the electrode is baked in a vacuum environment at 120° C. for 12 hours, then the electrode is putted into the glove box, using lithium metal as the counter electrode and 1M LiPF6 with ethylene carbonate (EC) and diethyl carbonate (DEC) as the electrolyte, in which ethylene carbonate and diethyl carbonate were mixed at a volume ratio of 1:1, button-type half-cell is assembled with lithium metal, separator, electrolyte and electrode and the subsequent electrical performance test then carried out. The results were shown in FIGS. 4 and 5.

FIG. 4 shows the results of the discharge capacity of the batteries with electrode made of the LiNi0.5Mn1.5O4-δ material and the battery with electrode made of LIC@LiNi_{0.5}Mn_{1.5}O_{4-δ} material, discharged at rate of 0.2 C, 0.5 C, 1 C, 2 C, 4 C, 6 C, 8 C, and 10 C.

As shown in FIG. 4, after discharge at each discharge rate, the capacity retention capacity of the battery using LIC@LiNi_{0.5}Mn_{1.5}O_{4-δ} material as the electrode is higher than that of the battery using LiNi_{0.5}Mn_{1.5}O_{4-δ} material as the electrode.

FIG. 5 shows the results of the discharge capacity of the battery with electrode made of the LiNi0.5Mn1.5O4-δ material and the battery with electrode made of LIC@LiNi_{0.5}Mn_{1.5}O_{4-δ} material after 200 discharged cycles.

As shown in FIG. 5, after discharge for 200 cycles, the capacity retention capacity of the battery using LIC@LiNi_{0.5}Mn_{1.5}O_{4-δ} material as the electrode is higher than that of the battery using LiNi_{0.5}Mn_{1.5}O_{4-δ} material as the electrode.

In other words, using LIC@LiNi_{0.5}Mn_{1.5}O_{4-δ} as the cathode material of lithium batteries can improve the rate and cycle performance. LiNi_{0.5}Mn_{1.5}O_{4-δ} as the core can provide rate performance, and LIC coating can avoid problems such as direct contact of LiNi_{0.5}Mn_{1.5}O_{4-δ} with the electrolyte and manganese dissolution, and can provide cycle stability.

The above description should be considered as only the discussion of the preferred embodiments of the present invention. However, a person having ordinary skill in the art may make various modifications without deviating from the present invention. Those modifications still fall within the scope of the present invention.

What is claimed is:

1. A cathode material, comprising:
a core, composed of a first material; and
a coating, covering the core and composed of a second material,
wherein
the first material is represented by: LiNi_{0.5}Mn_{1.5}O_{4-δ}, wherein δ>0, and
the second material is Li-containing ternary halide.

2. The cathode material as claimed in claim 1, wherein the second material is represented by: LiₐMX_{b},
wherein M is non-lithium metal,
X is halogen, and
a and b are positive integers.

3. The cathode material as claimed in claim 1, wherein the second material is lithium-indium chloride (Li₃InCl₆).

4. The cathode material as claimed in claim 1, wherein the coating has a thickness of 5˜60 nm.

5. A manufacturing method of a cathode material, comprising:
a co-precipitation step of mixing a nickel-manganese metal solution, a sodium hydroxide solution and an ammonia solution in a container to obtain a co-precipitation product, and drying and then sieving the co-precipitation product to obtain a nickel-manganese precursor;
a sintering step of adding and mixing lithium salt to the precursor and then performing a sintering treatment in an oxygen-deficient environment thereon to obtain a first material; and
a coating step of adding and mixing the first material to halide to obtain a coating mixture, and then drying and vacuum-sintering the coating mixture to obtain the cathode material,
wherein the molar ratio of nickel to manganese in the nickel-manganese metal solution is 1:3.

6. The manufacturing method as claimed in claim 5, wherein in the sintering step, the sintering treatment is carried out in a nitrogen atmosphere.

7. The manufacturing method as claimed in claim 5, wherein in the sintering step, the sintering treatment is carried out at a temperature of 500˜1000° C. for 1˜13 hours.

8. The manufacturing method as claimed in claim 5, wherein in the coating step, the weight of the halide accounts for 1 to 10% of the total weight of the coating mixture.

9. The manufacturing method as claimed in claim 5, wherein in the coating step, the sintering treatment is carried out at a temperature of 150˜250° C. for 4˜6 hours.
